(19) United States
(12) Patent Application Publication
(10) Pub. No.: US 2006/0081272 A1
(43) Pub. Date: Apr. 20, 2006

(54) Dish washer and method for detecting failure of pump thereof

(75) Inventor: Tae Young Jung, Hwasung-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/217,438

(22) Filed: Sep. 2, 2005

(30) Foreign Application Priority Data
Oct. 18, 2004 (KR) 2004-83246

(51) Int. Cl. B08B 7/04; B08B 3/00

(52) U.S. Cl. 134/18; 134/56 D; 134/58 D

(57) ABSTRACT

A dish washer, which detects failure of a washing pump, and a method for detecting failure of the washing pump of the dish washer. The method detects failure of the washing pump of the dish washer by measuring the temperature of water at different locations within the dish washer. It is determined that the washing pump has failed when a temperature difference the water temperature measured at one location in the dish washer and the water temperature at different location is greater than or equal to a reference value.

### CROSS-REFERENCE TO RELATED APPLICATION

This application claims priority from Korean Patent Application No. 2004-83246, filed Oct. 18, 2004, in the Korean Intellectual Property Office, the disclosure of which is incorporated herein by reference.

### BACKGROUND OF THE INVENTION

1. Field of the Invention

The present invention relates to a dish washer and a method for detecting failure of a washing pump thereof, and more particularly, to a dish washer that detects whether or not a washing pump is failed, and a method for detecting failure of the washing pump of the dish washer.

2. Description of the Related Art

Generally, a dish washer, as disclosed by Korean Patent Laid-open Publication No. 2002-0077643, comprises a washing chamber formed in a main body, dish baskets installed in the washing chamber for containing dishes, a water supply valve for adjusting the quantity of water supplied to the washing chamber, spray nozzles for spraying water together with detergent to the inside of the washing chamber, a washing pump for supplying water of a high pressure to the spray nozzles, and a heater for heating the water supplied to the spray nozzles.

When a user inputs washing instructions to the above-described conventional dish washer, the water supply valve is opened for a designated time so that water is supplied to the washing chamber, and the washing pump is operated so that the water is sprayed from the spray nozzles, thereby washing dishes in the washing chamber. Further, the heater is operated together with the operation of the washing pump so that heated water is sprayed, thereby improving a washing effect.

In the conventional dish washer, when the washing operation is performed by the simultaneous operation of the washing pump and the heater, it is difficult to detect failure of the washing pump, in which the water is not circulated. Further, when the washing pump is failed, the heater is continuously operated so that the temperature of the water in the heater is excessively increased, thereby being overheated and broken or causing a fire.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

Therefore, one aspect of the invention is to provide a dish washer that detects failure of a washing pump, and a method for detecting failure of the washing pump thereof.

Another aspect of the invention is to provide a dish washer that prevents operation of a heater when a washing pump is failed, and a method for detecting failure of the washing pump thereof.

In accordance with one aspect, the present invention provides a method for detecting failure of a washing pump of a dish washer, which has a washing chamber, the washing pump for circulating water in the washing chamber through a connection pipe, and a heater for heating the water flowing through the connection pipe, comprising: measuring a temperature of water at a first measuring point; measuring a temperature of water at a second measuring point apart from the first measuring point; and determining that the washing pump is failed when a difference between the water temperature at the first measuring point and the water temperature at the second measuring point is greater than or equal to a reference value.

In accordance with another aspect, the present invention provides a dish washer comprising: a washing chamber; a washing pump for circulating water in the washing chamber through a connection pipe; a heater for heating the water flowing through the connection pipe; a first temperature sensor for measuring a temperature of water at a first measuring point; a second temperature sensor for measuring a temperature of water at a second measuring point apart from the first measuring point; and a control unit for determining that the washing pump is failed when a difference between the water temperature at the first measuring point and the water temperature at the second measuring point is greater than or equal to a reference value.

Additional aspects and/or advantages of the invention will be set forth in the description that follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the illustrative, non-limiting embodiments, taken in conjunction with the accompanying drawings in which:

FIG. 1 is a longitudinal sectional view of a dish washer, to which a method for detecting failure of a washing pump consistent with an exemplary embodiment of the present invention is applied;

FIG. 2 is a transversal sectional view of the dish washer of FIG. 1;

FIG. 3 is a block diagram of the dish washer shown in FIGS. 1 and 2; and

FIG. 4 is a flow chart illustrating a method for detecting failure of a washing pump of the dish washer shown in FIGS. 1 to 3.

### DETAILED DESCRIPTION OF THE ILLUSTRATIVE, NON-LIMITING EMBODIMENTS OF THE INVENTION

Reference will now be made in detail to an illustrative, non-limiting embodiment of the present invention, an example of which is illustrated in the accompanying drawings, wherein like reference numerals refer to like elements throughout. The illustrative, non-limiting embodiment is described below to explain the present invention by referring to the annexed drawings.

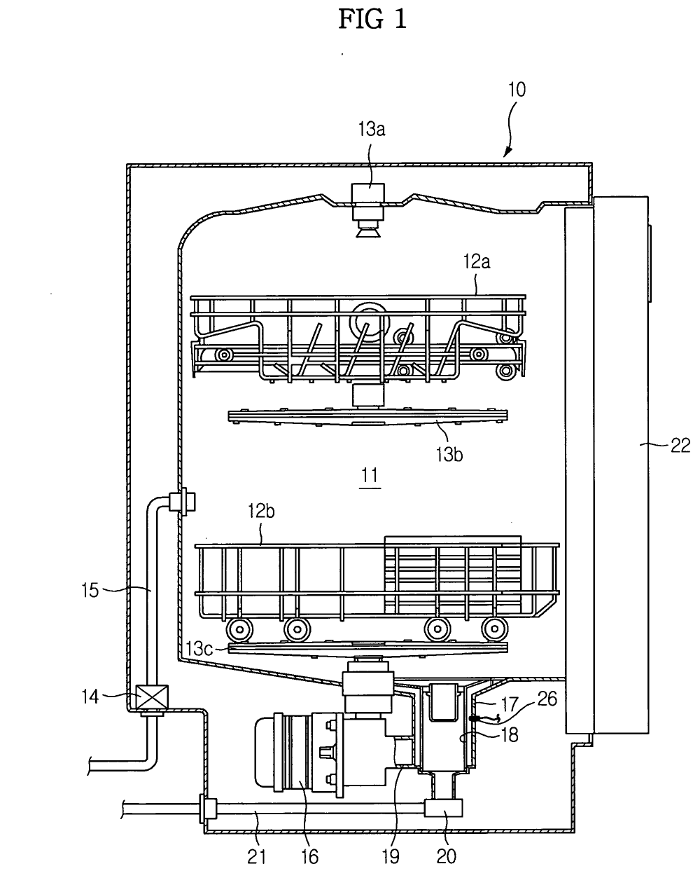

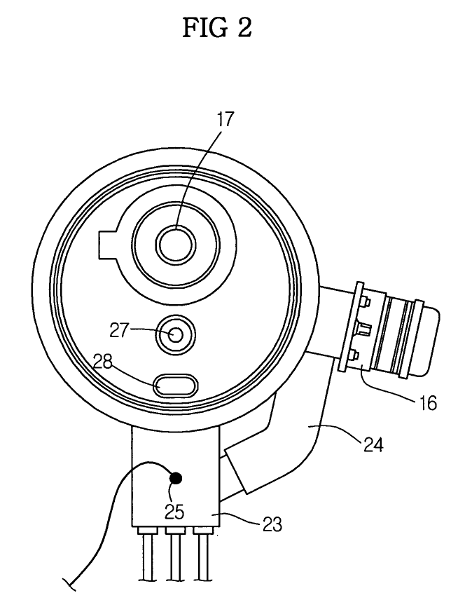

As shown in FIGS. 1 and 2, a dish washer, to which a method for detecting failure of a washing pump consistent with an exemplary embodiment of the present invention is applied, comprises a main body 10, in which a washing chamber 11 provided with an opened front surface is installed, and a door 22 vertically rotatably installed on the front surface of the main body 10 for opening and closing the washing chamber 11.

Dish baskets 12a and 12b for collecting dishes are installed in upper and lower parts of the washing chamber 11. In order to spray water onto the dishes collected by the dish baskets 12a and 12b, a stationary spray nozzle 13a is installed in the upper part of the washing chamber 12, and rotary spray nozzles 13b and 13c are respectively installed in the central and lower parts of the washing chamber 12. A water supply pipe 15 comprising a water supply valve 14 for supplying water to the inside of the washing chamber 11 in an initial stage of a washing operation is installed in the rear of the washing chamber 11.

A washing pump 16 for applying pressure to water and supplying the water to the spray nozzles 13a, 13b, and 13c in the washing chamber 11, a heater 23 for heating the water supplied from the washing pump 16, and a connection pipe 24 connecting the washing pump 16 and the heater 23 are connected to the lower part of the washing chamber 11. A water collection portion 17, which is depressed in a designated depth, for collecting water and dirt is formed in the bottom surface of the washing chamber 11, and a filter 18 for filtering out the dirt is installed in the water collection portion 17. A suction pipe 19 for re-circulating the water filtrated by the filter 18 is connected between the washing pump 16 and the water collection portion 17, and a drainage pump 20 for discharging the water after the washing operation is completed and a drainage pipe 21 extended from the drainage pump 20 to the outside of the main body 10 are installed on the lower part of the water collection portion 17.

A heater temperature sensor 25 for measuring the temperature of the water in the heater 23 is installed on a case of the heater 23, and a water collection portion temperature sensor 26 for measuring the temperature of the water in the washing chamber 11 is installed in the water collection portion 17. In FIG. 2, non-described reference numeral 27 represents a hole for supplying the water heated by the heater 23 to the lower rotary spray nozzle 13c, and non-described reference numeral 28 represents a hole for supplying the water heated by the heater 23 to the central rotary spray nozzle 13b and the stationary spray nozzle 13a.

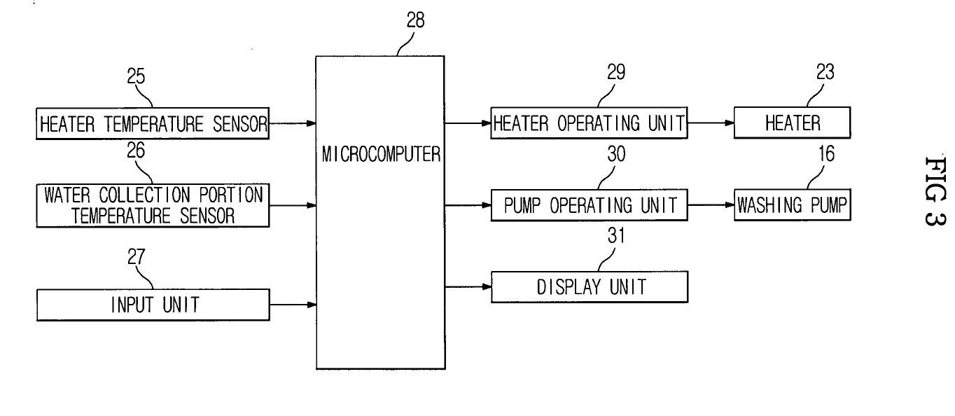

As shown in FIG. 3, in addition to the components shown in FIGS. 1 and 2, the dish washer, to which the method for detecting failure of the pump in accordance with an illustrative, non-limiting embodiment of the present invention is applied, further comprises a heater operating unit 29 for operating the heater 23, a pump operating unit 30 for operating the washing pump 16, a display unit 31 for displaying the operating state of the dish washer, an input unit 27 for allowing a user to input various control instructions therethrough, and a microcomputer 28 for controlling the components of the dish washer.

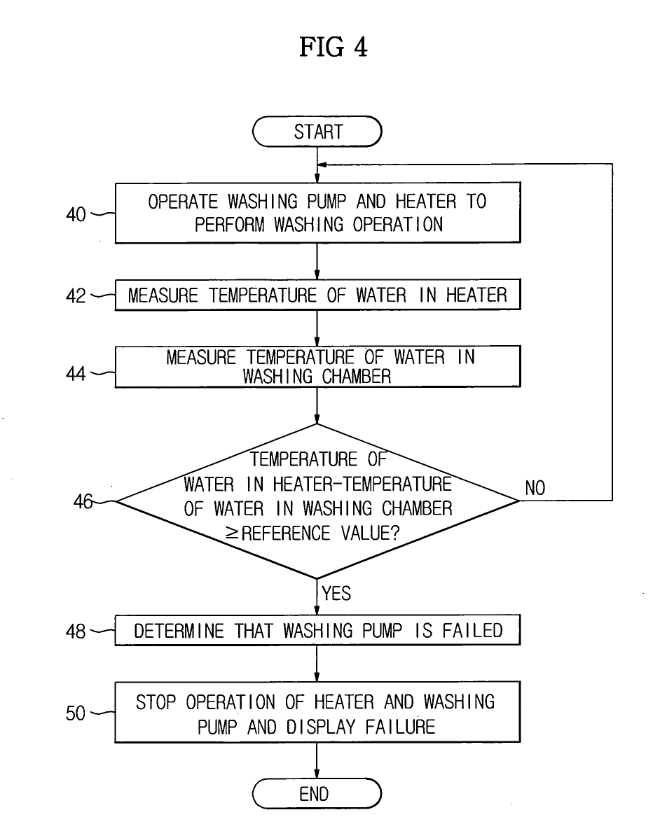

Hereinafter, with reference to FIG. 4, the method for detecting failure of the pump of the dish washer in accordance with an illustrative, non-limiting embodiment of the present invention will be described.

When a user inputs washing instructions through the input unit 27, the water supply valve 14 is opened for a designated time so that water is supplied to the washing chamber 11. When the designated time has elapsed, the water supply valve 13 is closed and the washing pump 16 and the heater 23 are operated so that the heated water is supplied to dishes through the spray nozzles 13a, 13b, and 13c (40).

During the above washing operation, the heater temperature sensor 25 measures the temperature of the water in the heater 23 (42), and the water collection portion temperature sensor 26 measures the temperature of the water in the washing chamber 11 (44). Thereafter, it is determined whether or not a difference of the temperatures between the water in the heater 23 and the water in the washing chamber 11 is more than a reference value (46). Here, the reference value may be set to different values according to the capacity of the heater 23 installed in the dish washer, and is stored in advance in the microcomputer 28.

In the case that the difference of the temperatures between the water in the heater 23 and the water in the washing chamber 11 is less than the reference value, the method returns to step 40, and in the case that the difference of the temperatures between the water in the heater 23 and the water in the washing chamber 11 is greater than or equal to the reference value, it is estimated that the water is not circulated due to the failure of the washing pump 16 and it is determined that the washing pump 16 is failed (49).

When the failure of the washing pump 16 is detected, the operation of the heater 23 and the washing pump 16 is stopped and the failure of the washing pump 16 is displayed to the outside through the display unit 31 (50).

Although this illustrative, non-limiting embodiment describes the sensors respectively installed in the heater 23 and the water collection portion 17 so that the difference of the temperatures between the water in the heater 23 and the water in the washing chamber 11 is sensed, the installed positions of the sensors are not limited thereto. That is, the sensors may be installed at other positions so long as the difference of the temperatures between the water in the heater 23 and the water in the washing chamber 11 due to the failure of the washing pump 16 can be sensed. For example, the heater temperature sensor 25 may be installed in the connection pipe 24 adjacent to the heater 23, and the water collection portion temperature sensor 26 may be installed at an outlet of the washing pump 16 or in the suction pipe 19.

As apparent from the above description, the present invention provides a dish washer, which compares a temperature of water at a first measuring point within the dish washer and a temperature of water at a second measuring point within the dish washer that is apart from the first measuring point to detect failure of a washing pump, and a method for detecting failure of the washing pump of the dish washer.

Further, the dish washer of the present invention stops the operation of the heater and the washing pump when the failure of the washing pump is detected, thereby preventing the heater from being overheated due to the failure of the washing pump and reducing the probability of a fire.

Although an illustrative, non-limiting embodiment of the invention has been shown and described, it would be appreciated by those skilled in the art that changes may be made in this embodiment without departing from the principles and spirit of the invention, the scope of which is defined in the claims and their equivalents.

What is claimed is:

1. A method for detecting failure of a washing pump of a dish washer, which has a washing chamber, the washing pump for circulating water in the washing chamber through a connection pipe, and a heater for heating the water flowing through the connection pipe, comprising:
measuring a temperature of water at a first measuring point;
measuring a temperature of water at a second measuring point that is apart from the first measuring point; and
determining that the washing pump is failed when a temperature difference between a water temperature measured at the first measuring point and a water temperature measured at the second measuring point is greater than or equal to a reference value.

2. The method as set forth in claim 1, wherein the second measuring point is located in the washing chamber.

3. The method as set forth in claim 1, wherein the second measuring point is located at an outlet of the washing pump.

4. The method as set forth in claim 1, wherein the second measuring point is located at a suction pipe connected to the washing chamber.

5. The method as set forth in claim 1, wherein the first measuring point is located in the heater.

6. The method as set forth in claim 1, wherein the first measuring point is located in the connection pipe.

7. The method as set forth in claim 1, wherein the method further comprises disabling the heater when the temperature difference is greater than or equal to the reference value.

8. The method as set forth in claim 7, wherein the method further comprises disabling the washing pump when the temperature difference is greater than or equal to the reference value.

9. The method as set forth in claim 7, wherein the method further comprises displaying a message to a user that the washing pump has failed if the temperature difference is greater than or equal to the reference value.

10. A dish washer comprising:
a washing chamber;
a washing pump for circulating water in the washing chamber through a connection pipe;
a heater for heating the water flowing through the connection pipe;
a first temperature sensor for measuring a temperature of water at first measuring point;
a second temperature sensor for measuring a temperature of water at a second measuring point that is apart from the first measuring point; and
a control unit for determining that the washing pump is failed when a temperature difference between a water temperature measured at the first measuring point and a water temperature measured at the second measuring point is greater than or equal to a reference value.

11. The dish washer as set forth in claim 10, wherein the first temperature sensor is installed in the heater.

12. The dish washer as set forth in claim 10, wherein the first temperature sensor is installed in the connection pipe.

13. The dish washer as set forth in claim 10, wherein the second temperature sensor is installed in the washing chamber.

14. The dish washer as set forth in claim 10, wherein the second temperature sensor is installed at an outlet of the washing pump.

15. The dish washer as set forth in claim 10, wherein the second temperature sensor is installed at a suction pipe connected to the washing chamber.

16. The dish washer as set forth in claim 10, wherein the control unit disables the heater when the temperature difference is greater than or equal to the reference value.

17. The dish washer as set forth in claim 16, wherein the control unit disables the washing pump when the temperature difference is greater than or equal to the reference value.

18. The dish washer as set forth in claim 16, wherein a display unit, connected to the control unit, displays a message to a user that the washing pump has failed if the temperature difference is greater than or equal to the reference value.
